(19) United States
(12) Patent Application Publication
(10) Pub. No.: US 2012/0007833 A1
(43) Pub. Date: Jan. 12, 2012

(54) PORTABLE ELECTRONIC DEVICE AND CONTROL METHOD THEREOF

(75) Inventors: HSIAO-CHUN LIU, Tu-Cheng (TW); CHAO-YUN YU, Tu-Cheng (TW)

(73) Assignee: CHI MEI COMMUNICATION SYSTEMS, INC., Tu-Cheng City (TW)

(21) Appl. No.: 12/916,648

(22) Filed: Nov. 1, 2010

(30) Foreign Application Priority Data
Jul. 9, 2010 (TW) 99122585

(51) Int. Cl. G06F 3/042

(52) U.S. Cl. 345/175

(57) ABSTRACT

A portable electronic device and control method thereof perform an unlocking operation and several page turning operations for a display of the portable electronic device. Light intensities in several positions of the light sensors are detected in a preset time period. The portable electronic device determines whether the operating mode is a predetermined operating mode and determines whether the portable electronic device is locked by the detected light intensities. The portable electronic device unlocks the portable electronic device upon detecting the portable electronic device is locked. Furthermore, the portable electronic executes at least one page turning operation on the display unit upon detecting the portable electronic device is unlocked.

### BACKGROUND

1. Technical Field

Embodiments of the present disclosure relate to portable electronic devices, and more particularly to a portable electronic device and a control method thereof.

2. Description of Related Art

Touch panels frequently provide a more convenient data input method than keyboard/mouse combinations. However, operation of the touch panel can easily damage the panel surface. In addition, if the touch panel is not calibrated with prolonged use, accuracy of the input can deteriorate.

### BRIEF DESCRIPTION OF THE DRAWINGS

FIG. 1 is a block diagram of one embodiment of a portable electronic device.

FIG. 2 is a flowchart illustrating one embodiment of a method of controlling a portable electronic device.

FIG. 3 shows block S311 of FIG. 2 in detail.

FIG. 4-8 are schematic diagrams illustrating exemplary positions of the light sensor of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example. Java, C, or Assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

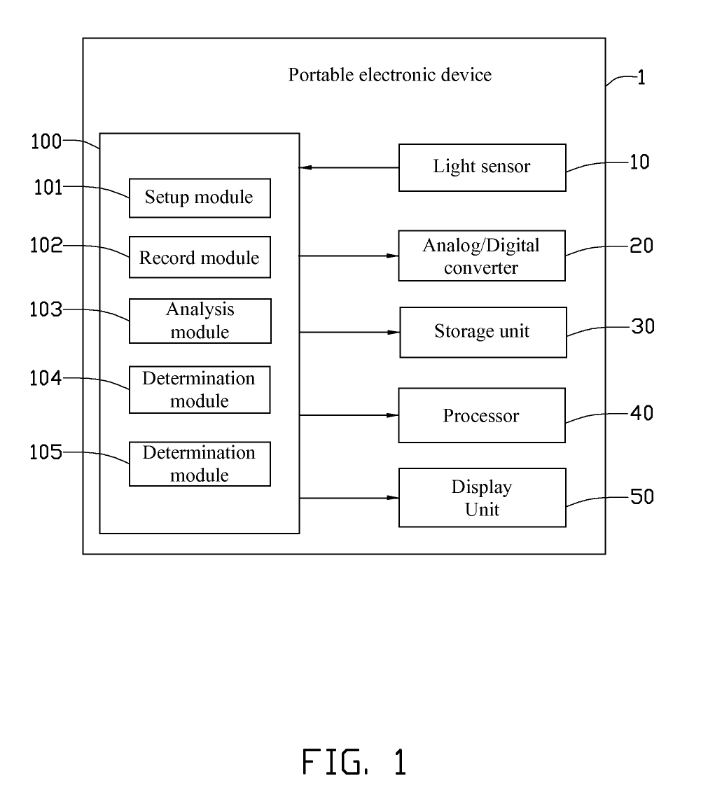

FIG. 1 is a block diagram of one embodiment of a portable electronic device 1. The portable electronic device 1 includes at least one light sensor 10, an analog/digital converter 20, a storage unit 30, a processor 40, a display unit 50 and a system 100. Depending on the embodiment, the portable electronic device 1 can be a mobile phone. In other embodiments, the portable electronic device 1 may be a personal digital assistant (PDA), a handheld game console, a digital camera (DC) or a handheld computer.

The portable electronic device 1 is generally controlled and coordinated by operating system software, such as UNIX, Linux, Windows 95, 98, NT, 2000, XP, Vista, Mac OS X, an embedded operating system, or any other compatible operating system. In other embodiments, the electronic device 1 may be controlled by a proprietary operating system. Conventional operating systems control and schedule computer processes for execution, perform memory management, provide file system, networking, and I/O services, and provide a user interface, such as a graphical user interface (GUI), among other things.

The at least one light sensor 10 is operable to detect variations of light intensity near the display unit 50 and output a plurality of corresponding analog signals to the analog/digital converter 20. The at least one light sensor 10 is configured in the front side of the display unit 50. By this design, the at least one light sensor 10 is able to detect variations of light intensity in front of the display unit 50. In addition, the at least one light sensor 10 is programmed to detect and register specific movements within their field of sensitivity.

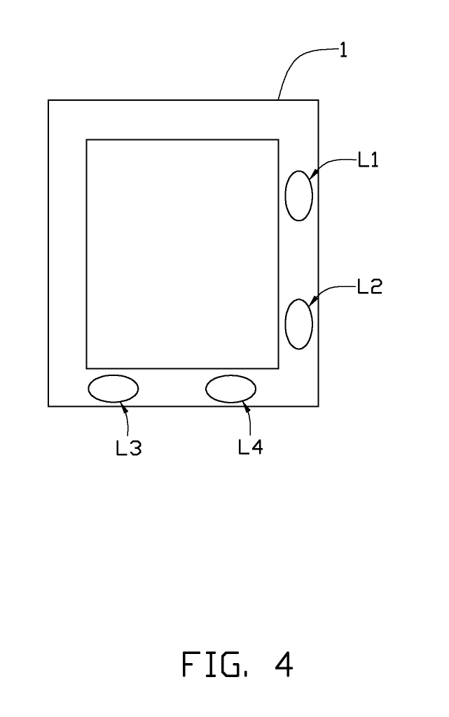

In one embodiment, the portable electronic device 1 includes four light sensors 10 around the display unit 50. Each two light sensors 10 combine to make up a sensing unit on one side of the display unit 50. As shown in FIG. 4, the first light sensor 10 is in the L1 position and the second light sensor 10 is in the L2 position. L1 and L2 are both at the right side of the display unit 50. In addition, the third light sensor 10 is in the L3 position and the fourth light sensor 10 is in the L4 position. The L3 and L4 are on the bottom of the display unit 50.

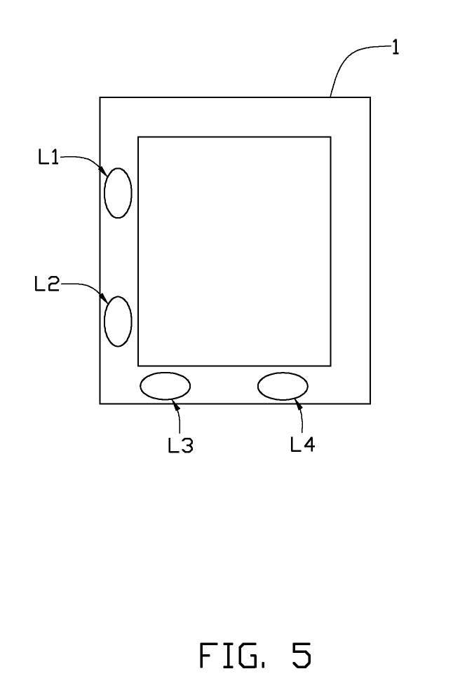

In other embodiments, four light sensors 10 around the display unit 50 and each two light sensors 10 combine to make up a sensing unit on one side of the display unit 50. A number of the light sensors can be an even number. As show in FIG. 5, the first light sensor 10 can be in the L1 position, the second light sensor 10 is in the L2 position, the third light sensor 10 is in the L3 position and the fourth light sensor 10 is in the L4 position. The L1 and L2 positions are on the right side of the display unit 50. In addition, The L3 and LA positions are on the bottom of the display unit 50.

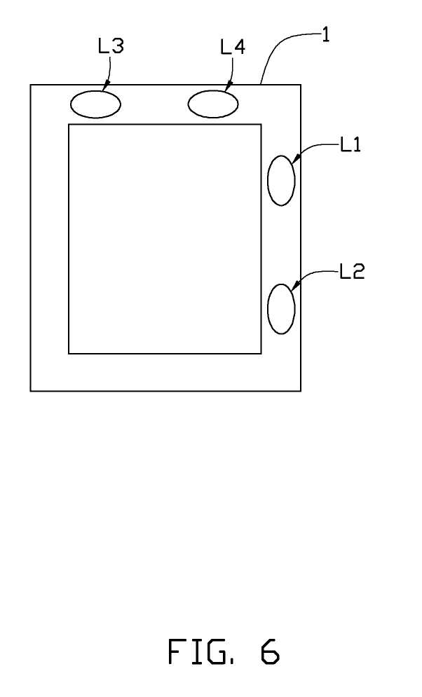

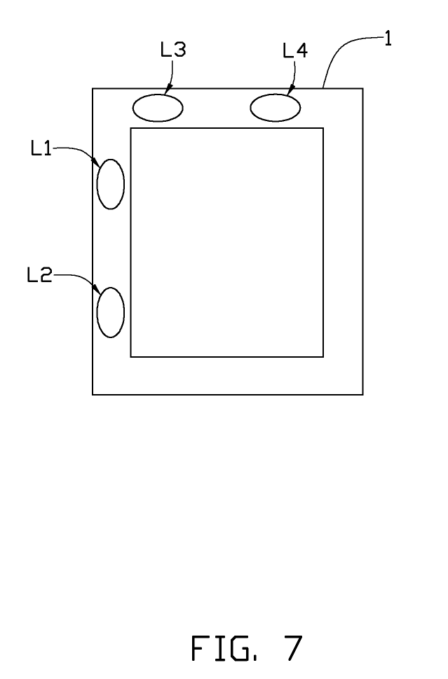

Accordingly, as shown in FIG. 6, the L1 and L2 positions are on the right side of the display unit 50 and the L3 and L4 positions are on the top of the display unit 50. As shown in FIG. 7, the L1 and L2 positions are on the left side of the display unit 50 and the L3 and L4 positions are on the top of the display unit 50.

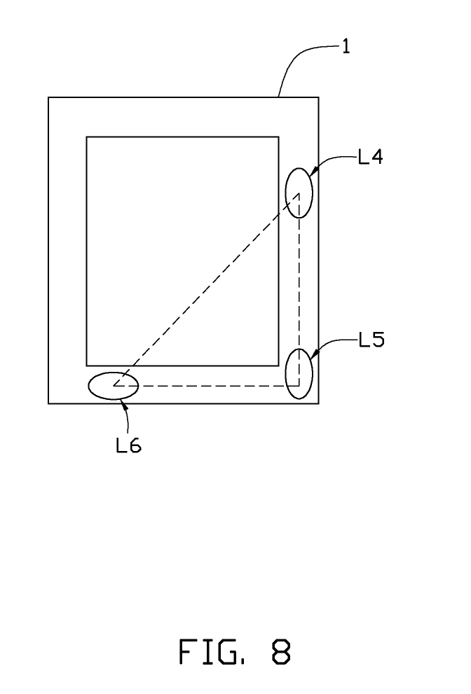

In other embodiments, the portable electronic device 1 can include three light sensors 10 around the display unit 50. As shown in FIG. 8, each two of the three light sensors 10 combine to make up a sensing unit and the three light sensors 10 in the shape of a right triangle around the display unit 50.

The analog/digital converter 20 is operable to transform the analog signals of the light intensity to a plurality of digital signals and save the digital signals in the storage unit 30. In one embodiment, the analog signal is a voltage signal and the analog/digital converter 20 presets one voltage threshold, such as 0.5V. If the voltage of the detected analog signal of light intensity exceeds the preset voltage threshold, the analog/digital converter 20 converts the detected voltage signal to a binary digit “1”. Otherwise, the analog/digital converter 20 converts the detected voltage signal to a binary digit “0”.

The storage unit 30 is electronically connected to the analog/digital converter 20, the processor 40, the system 100 and the display unit 50. The storage unit 30 is operable to store many kinds of data, such as module codes, computerized codes of the system 100, programs of an operating system and other applications of the portable electronic device 1. The storage unit 30 may include a hard disk drive, flash memory, RAM, ROM, cache, or external storage mediums.

The modules 101-105 may comprise computerized code in the form of one or more programs that are stored in the storage unit 30. The computerized code includes instructions that are executed by the at least one processor 40 to provide functions for modules 101-105. The at least one processor 40, as an example, may include a CPU, math coprocessor, shift register, for example.

The display unit 50 is operable to display information of the portable electronic device 1. The display unit 50 may be a display screen, a resistive touch screen or a capacitive touch screen.

The setup module 101 is operable to set operating commands corresponding to operating modes and control operations of the portable electronic device 1 in a plurality of light sensor positions, and save the set operating commands in the storage unit 30. In one embodiment, if the display unit 50 of the portable electronic device 1 is unlocked, the setup module 101 can set a page turning operating command as an up-down page turning operation upon detecting corresponding hand motions in front of the L1 position to the L2 position. When the display unit 50 is unlocked, the display unit 50 is turned on to display information. For example, a user interface is displayed in the display unit 50 if unlocked. The user interface can be a browser application. The setup module 101 sets the page turning operation command to control the user interface of the browser application, such as the up-down page turning operation to turn page up or turn page down. The setup module 101 can further set a page turning operating command as a down-up page turning operation upon detecting corresponding hand motions in front of the L2 position to the L1 position. The setup module 101 can further set a page turning operating command as left-right turning operation upon detecting corresponding hand motions in front of the L3 position to the L4 position. The setup module 101 can further set a page turning operating command as right-left page turning operation upon detecting corresponding hand motions in front of the L4 position to the L3 position. In other embodiments, the setup module 101 can set the operating mode of the portable electronic device 1 from locked to unlocked when detecting the up-down page turning operation, the down-up page turning operation, the left-right page turning operation or the right-left page turning operation. When the operation mode is locked, the portable electronic device 1 is not permitted to be operated. Otherwise, the operation mode is unlocked, the portable electronic device 1 is permitted to be operated. For example, the display unit 50 is turned on to display information when the portable electronic device 1 is from locked to unlocked.

The record module 102 is operable to record information of digital signals from the analog/digital converter 20 to the storage unit 30 at each light sensor position at several time points.

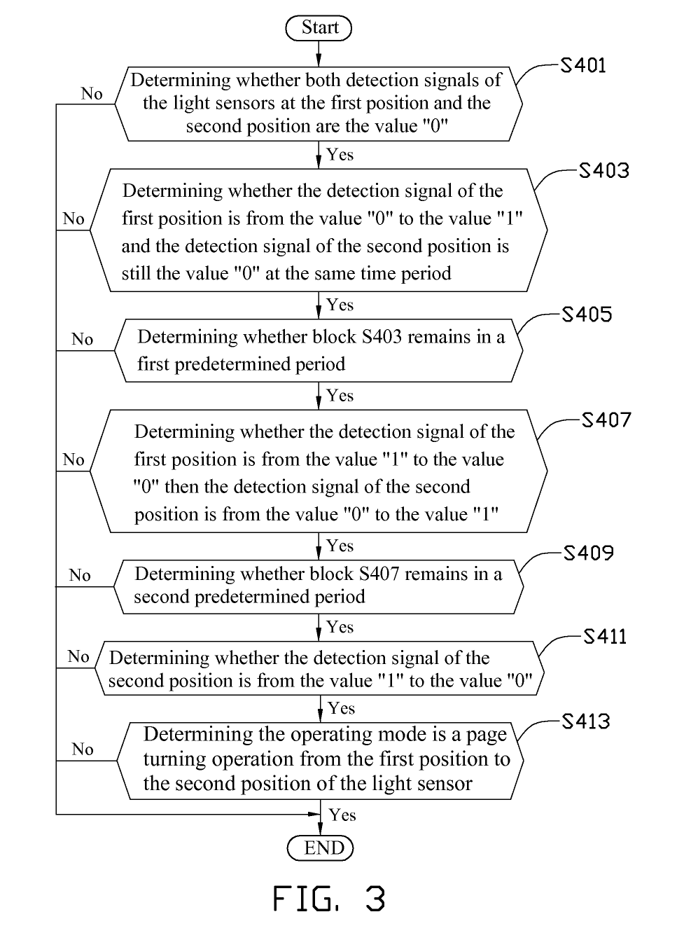

The analysis module 103 is operable to analyze the recorded information stored in the storage unit 30 and determine a current operating command of the portable electronic device 1 by the information analyzed. For example, FIG. 3 is an example of the analysis module 103 determines whether corresponding hand motions in front of the L1 position to the L2 position by the recorded information stored in the storage unit 30.

The determination module 104 is operable to determine whether the operating mode analyzed by the determination module 104 is a predetermined operating mode of the portable electronic device 1 and determine whether the portable electronic device 1 is locked.

The execution module 105 is operable to execute the operating commands corresponding to the operating modes or the unlocking/page turning operations from the storage unit 30 upon detecting the predetermined operating mode is active. For example, if the display unit 50 of the portable electronic device 1 is unlocked, the execution module 105 executes the up-down page turning operating command upon detecting corresponding hand motions in front of the L1 position to the L2 position.

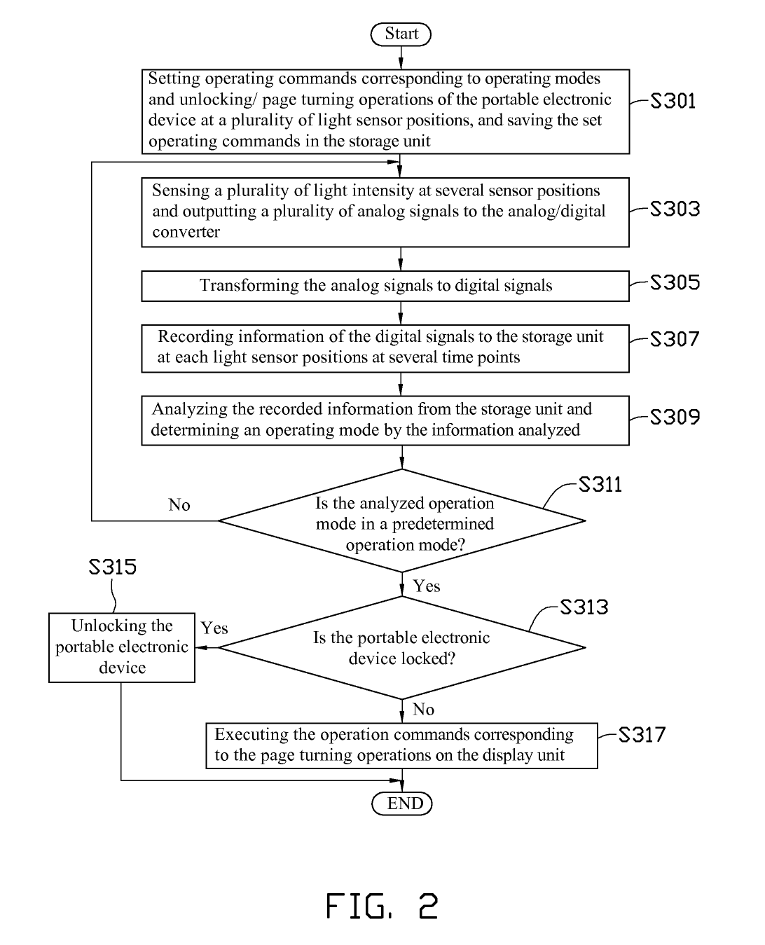

FIG. 2 is a flowchart illustrating one embodiment of a method of controlling a portable electronic device 1. Depending on the embodiment, additional blocks may be added, others deleted, and the ordering of the blocks may be changed.

In block S300, the least one light sensor 10

In block S301, the setup module 101 sets a plurality of operating commands corresponding to the operating modes and unlocking/page turning operations of the portable electronic device 1 at a plurality of light sensor positions, and save the plurality of set operating commands in the storage unit 30. The light sensors 10 are programmed to check the hand movements and react to specific movements. In one embodiment, if the display unit 50 of the portable electronic device 1 is unlocked, the setup module 101 can set a page turning operating command as an up-down page turning operation upon detecting corresponding hand motions in front of the L1 position to the L2 position. In other embodiments, the setup module 101 can set the operating mode of the portable electronic device 1 from locked to unlocked when detecting any kinds of page turning operations, such as the up-down page turning operation, the down-up page turning operation, the left-right page turning operation or the right-left page turning operation.

In block S303, the light sensors 10 sense a plurality of variation of light intensity of the sensor positions surrounding the display unit 50, transform the sensed light intensity to analog signals and output the analog signals of the light intensity to the analog/digital converter 20. In one embodiment, the portable electronic device 1 can include three light sensors 10 around the display unit 50 as shown in FIG. 8, each two of the three light sensors 10 combine to make up a sensing unit and the three light sensors 10 form a right triangle around the display unit 50. After sensing variations in intensity of the three sensors positions and outputs a plurality of analog signals of the detected light intensity to the analog/digital converter 20.

In block S305, the analog/digital converter 20 transforms the analog signals of the light intensity to a plurality of digital signals and saves the digital signals in the storage unit 30. In one embodiment, the analog signal is a voltage signal and the analog/digital converter 20 presets one voltage threshold, such as 0.5V. If the voltage of the detected analog signal of light intensity exceeds the preset voltage threshold, the analog/digital converter 20 converts the detected analog signal into a digital signal, such as a binary digit “1”. Otherwise, the analog/digital convener 20 converts the detected analog signal into a digital signal, such as a binary digit “0”.

In block S307, the record module 102 records information of digital signals from the analog/digital converter 20 to the storage unit 30 at each light sensor position at several time points. For example, the record module 102 records the detected digital signal value “0” at the L1 position at 10:21:05 and the detected digital signal value “1” at the L1 position at 10:21:06. The detected digital signal value “0” indicates the light sensor detects the light surrounding the display unit 50 and is not covered by an object.

The detected digital signal value “1” indicates the light sensor is covered by an object and can not detect the light surrounding the display unit 50. In the embodiments, the object can be a hand or at least one finger.

In block S309, the analysis module 103 analyzes the information of digital signals stored in the storage unit 30 and determine an operating mode of the portable electronic device 1 by the information analyzed. For example, the embodiment as shown in FIG. 3 is an example of the analysis module 103 determines whether corresponding hand motions in front of the L1 position to the L2 position by the recorded information stored in the storage unit 30.

In block S311, the determination module 104 determines whether the analyzed operating mode by the analysis module 103 is a predetermined operating mode of the portable electronic device 1. If not the predetermined operating mode, block S303 is implemented and the light sensors 10 continually sense the light intensity of each sensor position surrounding the display unit 50. If the predetermined operating mode is determined, block S313 is implemented and the determination module 104 further determines whether the portable electronic device 1 is locked. If the portable electronic device 1 is locked, block S315 is implemented and the execution module 105 executes an unlocking command stored in the storage unit 30. If the portable electronic device 1 is in unlocked, block S317 is implemented.

In block S317, the execution module 105 executes the operating commands corresponding to the page turning operations from the storage unit 30. For example, the execution module 105 executes the up-down page turning operating command upon detecting corresponding hand motions in front of the L1 position to the L2 position.

FIG. 3 shows block S311 of FIG. 2 in detail, in which an example of the system 100 determines the presence of corresponding hand motions in front of the L1 position to the L2 position.

In block S401, the analysis module 103 determines whether both detection signals of the light sensors at the first position and the second position are the value “0”. If not, the process is complete. If so, block S403 is implemented. For example, the analysis module 103 determines whether both detection signals of the light sensors at the L1 position and the L2 position are the value “0”.

In block S403, the analysis module 103 determines whether the detection signal of the first position is from the value “0” to the value “1” and the detection signal of the second position is still the value “0” at the same time period. In one embodiment, at least one motion occurs in front of the light sensors from the first position to the second position. Because the page turning operation is a gradual process from the first position to the second position, the first position is firstly covered by the single motion and the second location and the second position are not covered at the same period. Accordingly, the detection signal of the first position is from the value “0” to the value “1”, the value of detection signal of the second position is still “0” at the time of movement. In one embodiment, the analysis module 103 determines whether the detection signal of the first position (L1) is from the value “0” to the value “1” and determines whether the detection signal of the second position (L2) is the value “0” at the same time period.

In block S405, the analysis module 103 determines whether block S403 remains in a first predetermined period, such as from 10:21:06 am to 10:21:10 am. The setup module 101 sets the first predetermined period for determining whether the page turning operation is a desired operation. For example, the desired page turning operation from the first position to the second position takes time to implement, such as from 10:21:06 am to 10:21:10 am. Accidental page turning operation can not keep the status of block S403 at the first predetermined period. If block S405 remains in the first predetermined period, block S407 is implemented. If not, the process is complete.

In block S407, the analysis module 103 determines whether the detection signal of the first position is from the value “1” to the value “0” then the detection signal of the second position is from the value “0” to the value “1” during the page turning operation period. The setup module 101 sets the second time period for determining the status of light intensity. In one embodiment, the analysis module 103 determines whether the detection signal of the first position (L1) is from the value “1” to the value “0” then the detection signal of the second position (L2) is from the value “0” to the value “1” during the page turning operation period, such as from 10:21:10 am to 10:21:12 am. If so, block S409 is implemented. If not, the process is complete.

Accordingly, in block S409, the analysis module 103 determines whether block S407 remains in a second predetermined period. The setup module 101 sets the second predetermined period for determining whether the page turning operation is a desired operation. For example, the desired page turning operation from the first position to the second position takes time to implement, such as from 10:21:10 am to 10:21:12 am. An accidently page turning operation can not keep the status of block S407 at the second predetermined period. If block S407 remains in the second predetermined period, block S411 is implemented. If not, the process is complete.

In block S411, the analysis module 103 determines whether the detection signal of the second position is from the value “1” to the value “0”. For example, the analysis module 103 detects whether the detection signal of the second position (L2) is from the value “1” to the value “0” after the page turning operation of block S409. If so, block S413 is implemented. If not, the process is complete.

In block S413, the analysis module 103 determines the operating mode is a page turning operation from the first position to the second position of the light sensor.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A portable electronic device, comprising:
a storage unit;
a display unit;
at least one processor;
at least one light sensor to detect variations of light intensity near the display unit;
a setup module to set operating commands corresponding to operating modes and unlocking/page turning operations of the portable electronic device at a plurality of light sensor positions;
a record module to record information regarding the variations of light intensity of the plurality of light sensor positions to the storage unit at several time points;
an analysis module to determine an operating mode of the portable electronic device according to the information regarding the variations of light intensity;
a determination module to determine whether the operating mode analyzed by the analysis module is a predetermined operating mode of the portable electronic device; and
an execution module to execute the operating command corresponding to the operating modes and the unlocking/page turning operations upon detecting the predetermined operating mode is active.

2. The portable electronic device of claim 1, wherein the page turning operations of the portable electronic device include a up-down page turning operation, a down-up page turning operation, a left-right page turning operation, and a right-left page turning operation.

3. The portable electronic device of claim 1, wherein the determination module determines the operating mode is unlocked upon detecting that an original operating mode of the portable electronic device is locked and detecting one of the page turning operations executes on the display unit.

4. The portable electronic device of claim 1, wherein the light sensors are located around the display unit.

5. The portable electronic device of claim 1, wherein a number of the light sensors is an even number.

6. The portable electronic device of claim 1, wherein each two light sensors combine to make up a sensing unit on one side of the display unit of the portable electronic device.

7. The portable electronic device of claim 1, wherein the number of the light sensors is 3.

8. The portable electronic device of claim 7, wherein the light sensors are positioned to form a right triangle.

9. A method of controlling a portable electronic device, the portable electronic device comprising a plurality of light sensors, a display unit, a storage unit and an analysis module, the method comprising:
detecting variations of light intensity near the display unit using the plurality of light sensors;
setting operating commands corresponding to operating modes and unlocking/page turning operations of the portable electronic device at a plurality of light sensor positions;
recording information regarding the variations of light intensity of the plurality of light sensor positions to the storage unit at several time points;
determining an operating mode of the portable electronic device according to the information regarding the variations of light intensity;
determining whether the operating mode analyzed by the analysis module is a predetermined operating mode of the portable electronic device;
executing the operating commands corresponding to the operating modes and the unlocking/page turning operations upon detecting the predetermined operating mode is active; and
executing at least one page turning operation on the display unit.

10. The method of claim 9, wherein the page turning operation of the portable electronic device can be an up-down page turning operation, a down-up page turning operation, a left-right page turning operation, or a right-left page turning operation.

11. The method of claim 9, wherein the light sensors are disposed around the display unit.

12. The method of claim 9, wherein the number of light sensors is an even number.

13. The method of claim 9, wherein each two light sensors combine to make up a sensing unit on one side of the display unit of the portable electronic device.

14. The method of claim 9, wherein the number of the light sensors is 3.

15. The method of claim 13, wherein the light sensors are positioned to form a right triangle.

16. A storage medium having stored thereon instructions that, when executed by a processor, causes the processor to perform a method for controlling a portable electronic device, the portable electronic device comprising a plurality of light sensors, a display unit, a storage unit and an analysis module, the method comprising:
detecting variations of light intensity near the display unit using the plurality of light sensors;
setting operating commands corresponding to operating modes and unlocking/page turning operations of the portable electronic device at a plurality of light sensor positions;
recording information regarding the variations of light intensity of the plurality of light sensor positions to the storage unit at several time points;
determining an operating mode of the portable electronic device according to the information regarding the variations of light intensity;
determining whether the operating mode analyzed by the analysis module is a predetermined operating mode of the portable electronic device;
executing the operating commands corresponding to the operating modes and the unlocking/page turning operations upon detecting the predetermined operating mode is active; and
executing at least one page turning operation on the display unit.

17. The storage medium of claim 16, wherein the light sensors are disposed around the display unit.

18. The storage medium of claim 16, wherein the number of light sensors is an even number.

19. The storage medium of claim 16, wherein each two light sensors combine to make up a sensing unit on one side of the display unit of the portable electronic device.

20. The storage medium of claim 16, wherein the light sensors are positioned to form a right triangle.
